(19) United States
(12) Patent Application Publication
(10) Pub. No.: US 2021/0404493 A1
(43) Pub. Date: Dec. 30, 2021

(54) INTEGRATED FASTENING DEVICE

(71) Applicant: Hangzhou Golden Sun Auto Parts Co., Ltd., Hangzhou (CN)

(72) Inventors: Chenshan LIN, Hangzhou (CN); Jinqin FU, Hangzhou (CN); Shaoyong ZHENG, Hangzhou (CN); Xue'e WANG, Hangzhou (CN); Xiaohong TANG, Hangzhou (CN)

(21) Appl. No.: 17/001,154

(22) Filed: Aug. 24, 2020

(30) Foreign Application Priority Data
Jun. 30, 2020 (CN) 2020212453126

(51) Int. Cl. F16B 2/22

(52) U.S. Cl. CPC F16B 2/22; B60P 7/02

(57) ABSTRACT

This invention provides an integrated fastening device including a first clip seat, a second clip seat and a fastener, the fastener is used for fixing the first clip seat in the sliding groove of the mounting bar, the second clip seat is used for mounting on the cover, a hook is disposed at the first clip seat for snap-fitting with the second clip seat. The beneficial effects of this technical solution lie in: the hook and the second clip seat are fitted together to prevent longitudinal slippage between the hook and the cover.

### CROSS-REFERENCE TO RELATED APPLICATIONS

This Non-provisional application claims priority under 35 U.S.C. § 119(a) on Chinese Patent Application No(s). 202021245312.6 filed on Jun. 30, 2020, the entire contents of which are hereby incorporated by reference.

### BACKGROUND OF THE INVENTION

### Field of the Invention

This invention relates to a technical field of automobile accessories, and more particularly, to an integrated fastening device.

### Description of the Related Art

The patent CN111114258A provides a locking installation structure of the embedded cover frame. In this installation structure, a cargo bed of pickup trucks is provided with a mounting bar (reference numeral 350 in the figure), a limiting block (reference numeral 401 in the figure, which is mounted on the sliding groove of the mounting bar) and a locking tongue base (reference numeral 402 in the figure) are fitted together to fix the cover and the mounting bar. Therefore, the assembly stability of this structure is relatively poor, and longitudinal slippage between the cover and the mounting bar is prone to occur.

### BRIEF SUMMARY OF THE INVENTION

In order to overcome at least one deficiency of the prior art, this invention provides an integrated fastening device.

In order to achieve the above-mentioned objectives, this invention provides an integrated fastening device including a first clip seat, a second clip seat and a fastener, the fastener is used for fixing the first clip seat in the sliding groove of the mounting bar, the second clip seat is used for mounting on the cover, a hook is disposed at the first clip seat, and the hook is used for engaging with the second clip seat.

The function of this device is as follows: when the first clip seat is mounted on the mounting bar, and the second clip seat is mounted on the cover. When the second clip seat and the hook of the first clip seat are fitted together, and the hook is vertical to the mounting bar, the second clip seat is parallel to the cover, the hook and the second clip seat are kept parallel, so that, the hook and the second clip seat are fitted together to prevent longitudinal slippage between the hook and the cover.

Optionally, the first clip seat may include a bottom block and the hook, the hook is vertically fixed at the bottom block, and the hook and the bottom block are integrally formed.

The integral molding of the hook and the bottom block can improve a convenience of mount and a firmness of the first clip seat.

Optionally, the hook may be in the form of L-shape, the second clip seat may be in the form of L-shape.

When the L-shaped hook and the L-shaped second clip seat are fitted together, it can ensure the moment of the hook and the second clip seat is relatively short; and an installation position of the first clip seat and the second clip seat can be as close as possible to the edge to improve the stability of the mount.

Optionally, the hook may be provided with an arc chamfer, the second clip seat may be provided with an arc chamfer.

The purpose of setting the arc chamfer is to enable the hook and the second clip seat to smoothly slide into and out of the engagement.

Optionally, the fastener may be a bolt, the first clip seat may be provided with a bolt hole, the bolt is mounted to the bolt hole, the bolt is used for pressing the first clip seat tightly against the sliding groove of the mounting bar.

Optionally, the bolt may be a hexagon socket bolt.

Optionally, the bolt may be a metal bolt.

Optionally, the first clip seat may be made of plastic material, the second clip seat may be made of plastic material.

The first clip seat and the second clip seat are made of a plastic material to ensure the first clip seat and the second clip seat both have a certain toughness, and it is not easy to be brittle during use.

Optionally, a direction of a hook portion of the hook is downwards, and a direction of a hook portion of the second clip seat is upwards; the bottom block snaps into the sliding groove of the mounting bar, the bottom block comprises a first engaging portion and a second engaging portion, the first engaging portion and the second engaging portion are respectively snapped into an upper side wall and a lower side wall of the sliding groove, a thickness of the second engaging portion is greater than a thickness of the first engaging portion.

Optionally, the hook portion of the hook may be provided with at least one limiting protrusion, the hook portion of the second clip seat may be provided with at least one limiting groove, the limiting protrusion coordinates with the limiting groove.

Optionally, both sides of the hook portion of the hook may be provided with a side stopping block.

Optionally, the second clip seat may be provided with at least one stopping protrusion which is parallel to the hook.

Optionally, the integrated fastening device further includes a fastening adjustment element, the fastening adjustment element may be used for mounting the second clip seat on the cover, while fastening and adjusting a fit between the first clip seat and the second clip seat.

Optionally, the fastening adjustment element may include an adjustment knob and a screw, the screw is provided with a fixed end and an adjustment end, the outer wall of the adjustment end is provided with a thread section, the adjustment end and the adjustment knob are threadably fitted to adjust and fix the second clip seat.

The beneficial effects of this technical solution lie in: the hook and the second clip seat are fitted together to prevent longitudinal slippage between the hook and the cover.

These and other features, aspects, and advantages of the present invention will become better understood with regard to the following description, appended claims, and accompanying drawings.

### BRIEF DESCRIPTION OF THE DRAWINGS

FIG. 1 is a structural schematic diagram of a integrated fastening device;

FIG. 2 is an enlarged schematic diagram at A in FIG. 1;

FIG. 3 is a structural schematic diagram of the first clip seat in embodiment one;

FIG. 4 is a structural schematic diagram of the first clip seat in embodiment two;

FIG. 5 is a structural schematic diagram of the first clip seat in embodiment three;

FIG. 6 is a structural schematic diagram of the second clip seat in embodiment one;

FIG. 7 is a structural schematic diagram of the second clip seat in embodiment two.

The reference numerals in the figure are as follows:

1. cover; 2. mounting bar; 201. sliding groove; 3. first clip seat; 301. bottom block; 301a. first engaging portion; 301b. second engaging portion; 302. hook; 302a. limiting protrusion; 302b. side stopping block; 303. arc chamfer; 304. bolt hole; 4. fastener; 5. second clip seat; 51. limiting groove; 52. stopping protrusion; 6. fastening adjustment element; 61. adjustment knob; 62. screw; 621. fixed end; 622. adjustment end.

### DETAILED DESCRIPTION OF THE INVENTION

These and other objects, features and advantages of the present invention will become better understood with the following preferred embodiments, accompanying drawings and description in detail.

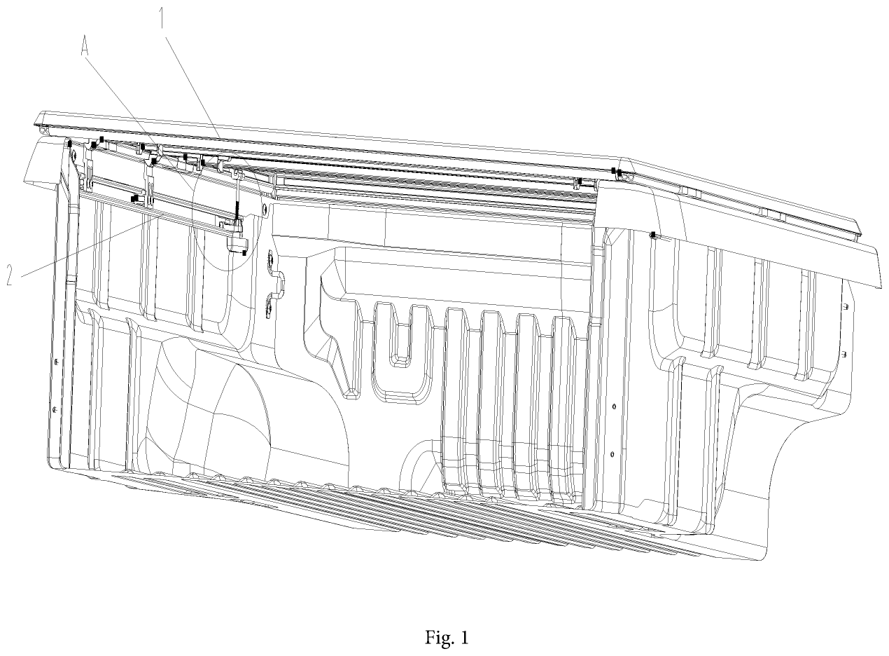

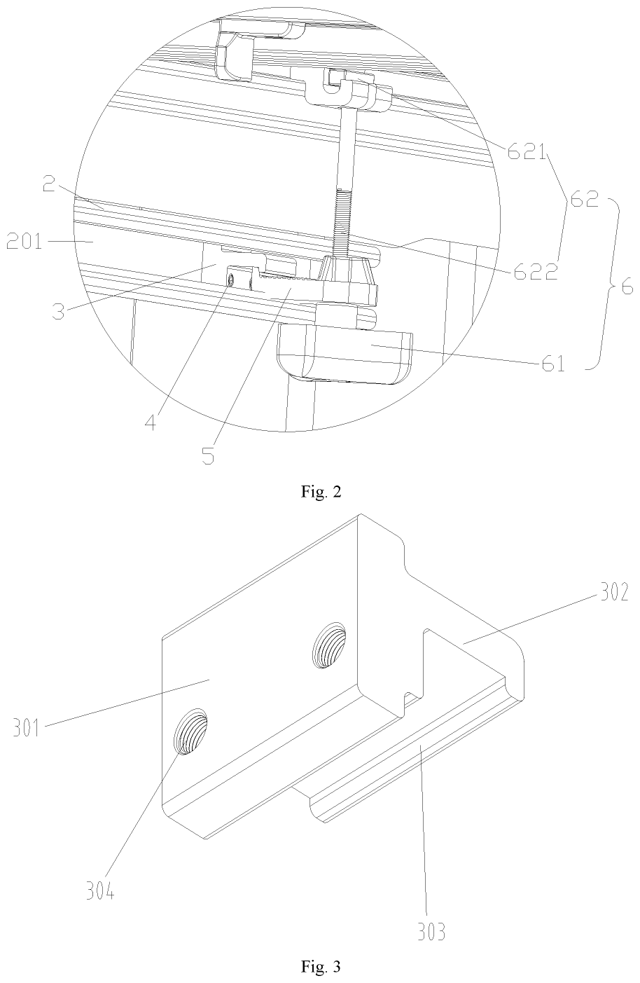

As shown in FIG. 1, FIG. 2 and FIG. 3, an integrated fastening device includes a first clip seat 3, a second clip seat 5 and a fastener 4. The fastener 4 is used for fixing the first clip seat 3 in the sliding groove 201 of the mounting bar 2. The second clip seat 5 is used for mounting on the cover 1. A hook 302 is disposed at the first clip seat 3 for snap-fitting with the second clip seat 5.

The function of this device is as follows: when the first clip seat 3 is mounted on the mounting bar 2, and the second clip seat 5 is mounted on the cover 1. When the second clip seat 5 and the hook 302 of the first clip seat 3 are fitted together, and the hook 302 is vertical to the mounting bar 2, the second clip seat 5 is parallel to the cover 1, the hook 302 and the second clip seat 5 are kept parallel, so that, the hook 302 and the second clip seat 5 are fitted together to prevent longitudinal slippage between the hook 302 and the cover 1.

As shown in FIG. 1, FIG. 2 and FIG. 3, the first clip seat 3 includes a bottom block 301 and a hook 302, the hook 302 is vertically fixed on the bottom block 301, and the hook 302 and the bottom block 301 are integrally formed.

The integral molding of the hook 302 and the bottom block 301 can improve the convenience of mount and the firmness of the first clip seat 3.

As shown in FIG. 1, FIG. 2 and FIG. 3, the hook 302 is in the form of L-shape, the second clip seat 5 is in the form of L-shape.

When the L-shaped hook 302 and the L-shaped second clip seat 5 are fitted together, it can ensure the moment of the hook 302 and the second clip seat 5 is relatively short; and an installation position of the first clip seat 3 and the second clip seat 5 can be as close as possible to the edge to improve the stability of the mount.

As shown in FIG. 1, FIG. 2 and FIG. 3, the hook 302 is provided with an arc chamfer 303, the second clip seat 5 is provided with an arc chamfer 303.

The purpose of setting the arc chamfer 303 is to enable the hook 302 and the second clip seat 5 to smoothly slide into and out of the engagement.

As shown in FIG. 1, FIG. 2 and FIG. 3, the fastener 4 is a bolt, the first clip seat 3 is provided with a bolt hole 304, the bolt is mounted to the bolt hole 304, the bolt is used for pressing the first clip seat 3 tightly against the sliding groove 201 of the mounting bar 2.

As shown in FIG. 1, FIG. 2 and FIG. 3, the bolt is a hexagon socket bolt.

As shown in FIG. 1, FIG. 2 and FIG. 3, the bolt is a metal bolt.

As shown in FIG. 1, FIG. 2 and FIG. 3, the first clip seat 3 is made of plastic material, the second clip seat 5 is made of plastic material.

The first clip seat 3 and the second clip seat 5 are made of plastic material to ensure the first clip seat 3 and the second clip seat 5 both have a certain toughness, and it is not easy to be brittle during use.

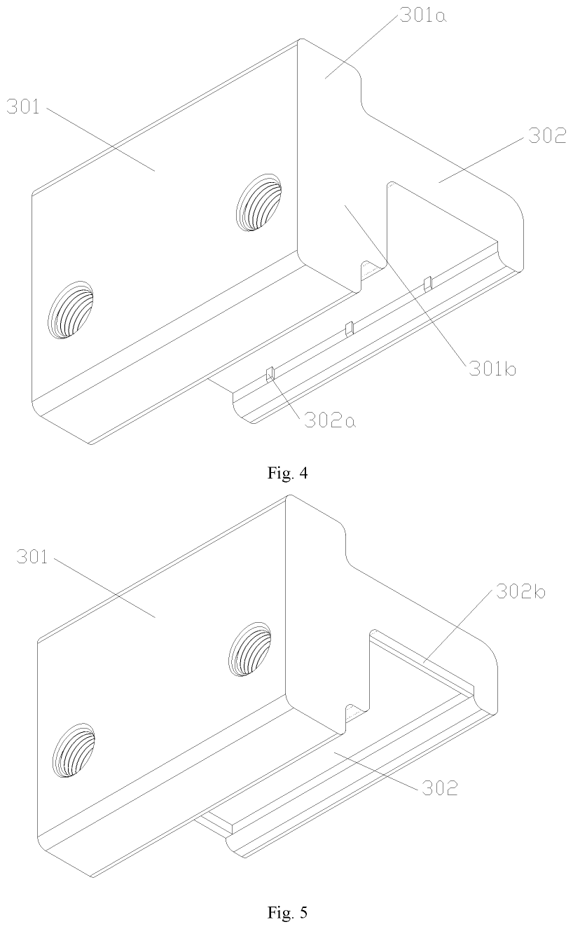

As shown in FIG. 2 and FIG. 4, the direction of the hook portion of the hook 302 is downward, and the direction of the hook portion of the second clip seat 5 is upward; the bottom block 301 is snapped into the sliding groove 201 of the mounting bar 2, the bottom block 301 comprises a first engaging portion 301a and a second engaging portion 301b, the first engaging portion 301a and the second engaging portion 301b are respectively snapped into the upper side wall and the lower side wall of the sliding groove 201, the thickness of the second engaging portion 301b is greater than the thickness of the first engaging portion 301a. When the cover 1 is connected by the second clip seat 5 and the hook portion of the hook 302, the second clip seat 5 exerts an upward force on the first clip seat 3, and the thickness of the second engaging portion 301b is relatively greater can effectively strengthen the structural strength of the bottom block 301, the thickness of the first engaging portion 301a is relatively smaller can reduce the weight of the bottom block 301.

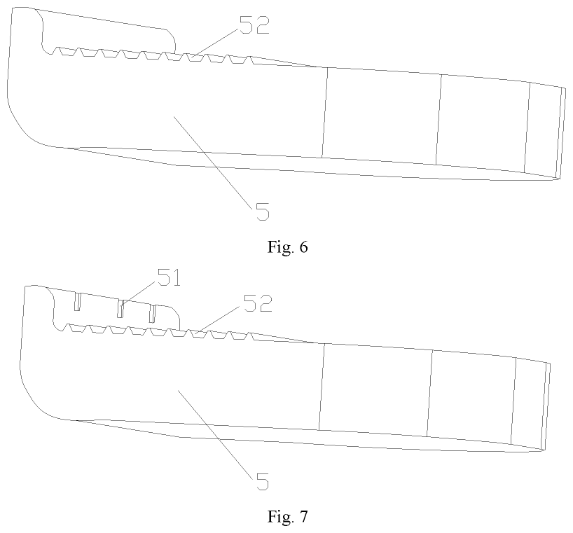

As shown in FIG. 2, FIG. 4 and FIG. 7, in an embodiment, the hook portion of the hook 302 is provided with at least one limiting protrusion 302a, the hook portion of the second clip seat 5 is provided with at least one limiting groove 51, the limiting protrusion 302a coordinates with the limiting groove 51. Since when the pickup trucks are driving, it will cause horizontal shaking between the cover 1 and the cargo bed during driving, the limiting protrusion 302a of the hook 302 and the limiting groove 51 of the second clip seat 5 are fitted together, it can prevent horizontal slippage between the hook 302 and the cover 1. But not confined to it, as shown in FIG. 2, FIG. 5 and FIG. 6, both sides of the hook portion of the hook 302 are provided with a side stopping block 302b, it also has the function of blocking and limiting the second clip seat 5 to avoid the second clip seat 5 slipping from the hook portion of the hook 302, the present invention is not limited to this.

As shown in FIG. 2, FIG. 6 and FIG. 7, the second clip seat 5 is provided with at least one stopping protrusion 52 which is parallel to the hook 302. The stopping protrusion 52 can block the movement of the hook 302 away from the hook portion of the second clip seat 5.

As shown in FIG. 2, the integrated fastening device further includes a fastening adjustment element 6, the fastening adjustment element 6 is used for mounting the second clip seat 5 on the cover 1, while fastening and adjusting the fit between the first clip seat 3 and the second clip seat 5, simple structure, and convenient assembly and disassembly. In one embodiment, the fastening adjustment element 6 includes an adjustment knob 61 and a screw 62, the screw 62 is provided with a fixed end 621 and an adjustment end 622, the outer wall of the adjustment end 622 is provided with a thread section, the adjustment end 622 and the adjustment knob 61 are threadably fitted to adjust and fix the second clip seat 5.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An integrated fastening device comprising a first clip seat, a second clip seat and a fastener, wherein the fastener is used for fixing the first clip seat in a sliding groove of a mounting bar, the second clip seat is used for mounting on a cover, a hook is disposed at the first clip seat, and the hook is used for engaging with the second clip seat.

2. The integrated fastening device of claim 1, wherein the first clip seat comprises a bottom block and the hook, the hook is vertically fixed at the bottom block, and the hook and the bottom block are integrally formed.

3. The integrated fastening device of claim 2, wherein the hook is in a form of L-shape, and the second clip seat is in a form of L-shape.

4. The integrated fastening device of claim 3, wherein the hook is provided with an arc chamfer, and the second clip seat is provided with an arc chamfer.

5. The integrated fastening device of claim 1, wherein the fastener is a bolt, the first clip seat is provided with a bolt hole, the bolt is mounted into the bolt hole, and the bolt is used for pressing the first clip seat tightly against the sliding groove of the mounting bar.

6. The integrated fastening device of claim 5, wherein the bolt is a hexagon socket bolt.

7. The integrated fastening device of claim 6, wherein the bolt is a metal bolt.

8. The integrated fastening device of claim 1, wherein the first clip seat is made of a plastic material, and the second clip seat is made of a plastic material.

9. The integrated fastening device of claim 3, wherein a direction of a hook portion of the hook is downwards, and a direction of a hook portion of the second clip seat is upwards; the bottom block snaps into the sliding groove of the mounting bar, the bottom block comprises a first engaging portion and a second engaging portion, the first engaging portion and the second engaging portion are respectively snapped into an upper side wall and a lower side wall of the sliding groove, a thickness of the second engaging portion is greater than a thickness of the first engaging portion.

10. The integrated fastening device of claim 9, wherein the hook portion of the hook is provided with at least one limiting protrusion, the hook portion of the second clip seat is provided with at least one limiting groove, the limiting protrusion coordinates with the limiting groove.

11. The integrated fastening device of claim 9, wherein both sides of the hook portion of the hook are provided with a side stopping block.

12. The integrated fastening device of claim 3, wherein the second clip seat is provided with at least one stopping protrusion, and the at least one stopping protrusion is parallel to the hook.

13. The integrated fastening device of claim 1, wherein the integrated fastening device further comprises a fastening adjustment element, and the fastening adjustment element is used for mounting the second clip seat at the cover, while fastening and adjusting a fit between the first clip seat and the second clip seat.

14. The integrated fastening device of claim 13, wherein the fastening adjustment element comprises an adjustment knob and a screw, and the screw is provided with a fixed end and an adjustment end, an outer wall of the adjustment end is provided with a thread section, the adjustment end and the adjustment knob are threaded together to adjust and fix the second clip seat.

15. The integrated fastening device of claim 2, wherein the integrated fastening device further comprises a fastening adjustment element, and the fastening adjustment element is used for mounting the second clip seat at the cover, while fastening and adjusting a fit between the first clip seat and the second clip seat.

16. The integrated fastening device of claim 3, wherein the integrated fastening device further comprises a fastening adjustment element, and the fastening adjustment element is used for mounting the second clip seat at the cover, while fastening and adjusting a fit between the first clip seat and the second clip seat.

17. The integrated fastening device of claim 4, wherein the integrated fastening device further comprises a fastening adjustment element, and the fastening adjustment element is used for mounting the second clip seat at the cover, while fastening and adjusting a fit between the first clip seat and the second clip seat.

18. The integrated fastening device of claim 5, wherein the integrated fastening device further comprises a fastening adjustment element, and the fastening adjustment element is used for mounting the second clip seat at the cover, while fastening and adjusting a fit between the first clip seat and the second clip seat.

19. The integrated fastening device of claim 9, wherein the integrated fastening device further comprises a fastening adjustment element, and the fastening adjustment element is used for mounting the second clip seat at the cover, while fastening and adjusting a fit between the first clip seat and the second clip seat.

20. The integrated fastening device of claim 10, wherein the integrated fastening device further comprises a fastening adjustment element, and the fastening adjustment element is used for mounting the second clip seat at the cover, while fastening and adjusting a fit between the first clip seat and the second clip seat.
